(19) United States
(12) Patent Application Publication
(10) Pub. No.: US 2011/0118374 A1
(43) Pub. Date: May 19, 2011

(54) Method for Preparing a Hard Film or Coating from a Cationically Cross-Linkable/Polymerizable Composition Comprising an Iodonium Borate and Giving Off an Acceptable Odour

(76) Inventors: Sophie Schneider, Ternay (FR); Jean-Marc Frances, Meyzieu (FR)

(21) Appl. No.: 12/810,770

(22) PCT Filed: Dec. 23, 2008
(86) PCT No.: PCT/EP08/68278

§ 371 Date: Jan. 31, 2011

(30) Foreign Application Priority Data
Dec. 27, 2007 (FR) 0760393

(51) Int. Cl. C08J 3/28; C08G 59/72; C08G 77/04; C09D 163/00; C09D 183/04; B05D 3/02; B05D 3/06

(52) U.S. Cl. 522/25; 528/361; 528/33; 523/400; 524/588; 427/387; 427/487; 427/386

(57) ABSTRACT

The invention relates to a method for preparing a hard film or coating from a composition based on monomers, oligomers and/or polymers capable of being involved in cationic polymerization and/or crosslinking reactions, comprising reactive functional radicals capable of forming intra-chain and inter-chain bridges, so as to obtain a polymerized and/or crosslinked film, coating or bulk (for example composite) material which has a certain level of hardness and a certain level of mechanical strength. The initiator system for polymerization and/or crosslinking, formed by an iodonium borate photoinitiator and by a photosensitizer chosen from di-anthracene-ethers, di-naphthalene-ethers and/or di-benzene-ethers, makes it possible to use a smaller amount of iodonium borate compared with the known systems, for an equivalent efficiency and with an acceptable odour being given off, in particular after polymerization/crosslinking.

The field of the invention is that of hard films or coatings obtained from compositions based on monomers, oligomers and/or polymers capable of being involved in cationic polymerization and/or cross-linking reactions, comprising reactive functional radicals capable of forming intra-chain and inter-chain bridges, so as to obtain a polymerized and/or cross-linked film, coating or bulk (for example composite) material which has a certain level of hardness and a certain level of mechanical strength.

More precisely, the present invention relates to a novel method for preparing a hard film or coating, from a cationically polymerizable and/or cross-linkable composition comprising at least one cross-linkable and/or polymerizable monomer, oligomer and/or polymer with reactive organofunctional groups and at least one initiator system comprising:

at least one photoinitiator based on at least one iodonium borate permitting the initiation and the development of formation reactions of polymers and/or of resins (resulting from cross-linking),

and optionally at least one electron-donating photosensitizer which acts as an energy relay for the photoinitiator.

The reactions more particularly involved are those in which cationic agents act as direct promoters of the inter-chain and/or intra-chain bonds.

In general, these reactions take place by photochemical and/or thermal activation and/or electron beam activation. As a practical example, the light energy of UV radiation permits the formation of active protagonists, for example by bond cleavage, thus triggering the polymerization and/or cross-linking reactions.

In the present description, the polymers and/or resins obtained are prepared from monomers, oligomers and/or polymers which are either (1) of organic nature, in particular solely hydrocarbon, or (2) of poly-organosiloxane nature, and comprise organofunctional groups in their structure, for example of the epoxide, oxetane, and/or alkenyl-ether type, which react cationically and by means of the new initiator systems according to the invention described below. It is also possible to use in addition (3) monomers, oligomers and/or polymers with acrylic groups, for example pure acrylic or methacrylic groups, which can be added to the cationic polymerization medium.

In the method of the invention, the compositions comprise the cationically polymerizable and/or cross-linkable base materials (monomers, oligomers and/or polymers), the initiator systems described below, and optionally one or more additives selected from those generally known in the applications for which these compositions are intended, i.e. hard films and coatings.

For example, these compositions can in particular be included in the composition of inks or varnishes. These varnishes are hard films or coatings, which for example have the following properties: printability, scratch resistance, dirt resistance and/or antimisting and which are applied for example on objects such as solid articles or substrates, in particular paper substrate, polymer film of the polyester or polyolefin type, aluminium substrate, and/or tin plate substrate. Some of these varnishes can be food-grade varnishes, used for example in packaging of food products.

These compositions can also serve as raw material for the production of non-stick coatings on various substrates, in particular paper, cardboard or similar, or polymer (film).

EP-0 562 897 describes initiators of for example photochemical polymerization and/or cross-linking, together with monomers, oligomers and/or polymers comprising reactive organofunctional groups in their structure. In particular, EP-0 562 897 discloses a composition comprising: 100 parts by weight of epoxidized monomer UVR-6110 TM (3,4-epoxycyclohexylmethyl-3,4-epoxycyclohexane carboxylate marketed by Union Carbide), and 2 parts by weight of photoinitiator [B(C₆F₅)₄]⁻, [(CH(CH₃)₂—C₆H₄)—I—C₆H₄—CH₃]⁺:

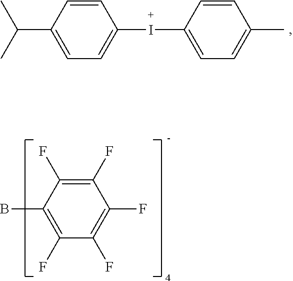

in solution at 50 wt. % in methanol. This composition is intended for the production of coatings on paper from epoxidized monomers, polymerized and cross-linked by UV irradiation. To assess the performance as initiator, the reactivity of the substrate/initiator pair and the rate of polymerization/cross-linking are evaluated, based on the feed speed necessary for the hardening of the layer coated on the paper as well as on the number of passes. The measured results are very good, but even so, to satisfy the productivity requirements of the applicators, the initiator systems need to give better and better performance. They must therefore enable the maximum possible reactivities and rates of polymerization/cross-linking to be reached, so as to be able to increase the coating speeds.

For perfecting the initiator systems according to EP-A-0 562 897, WO-A-99/05181 proposes novel initiator systems that were developed to satisfy more and more demanding requirements on productivity and manufacture, and comprising at least one onium borate and at least one benzophenone. The polymerizable and/or cross-linkable compositions including these new initiator systems and disclosed in WO-A-99/05181 are e.g. the following:
Polymerizable or cross-linkable monomer or polymer:

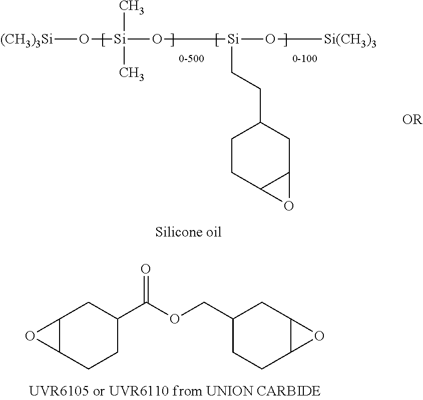

Photoinitiator system:
   [symbol] Onium borate photoinitiator
      [B(C₆F₅)₄]⁻, [(CH(CH₃)₂—C₆H₄)—I—C₆H₄—CH₃]⁺
   [symbol] Benzophenone photoinitiator

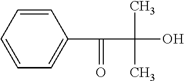

[symbol] Photosensitizer: chloro-1-propoxy-4-thioxanthone

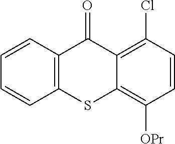

Solvent: TONE POLYOL® 301 alcohol from UNION CARBIDE.

According to WO-A-99/05181, the aforementioned photoinitiator system is mixed:

[symbol] with UVR6105 or UVR6110, a concentrated pigment base (titanium dioxide of the rutile type marketed under reference R960 by the company DUPONT DE NEMOURS) and a surfactant BYK 361 from the company BYK for producing white inks,

[symbol] with UVR6105 or UVR6110 and the surfactant BYK 361 alone to obtain an organic varnish,

[symbol] or with silicone oil to obtain a silicone varnish.

PCT application WO-A-2005/120439 relates to a photopolymerizable dental composition comprising:
a polymerizable monomer:

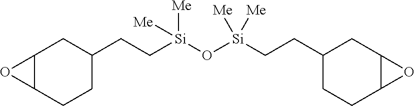

a photoinitiator system (3.3 wt. % relative to the monomer) based on:
   [B(C₆F₅)₄]⁻, [(CH(CH₃)₂—C₆H₄)—I—C₆H₄—CH₃]⁺
a photosensitizer (E) which is a salt of a thioxanthone substituted with at least one group G comprising an ammonium function:

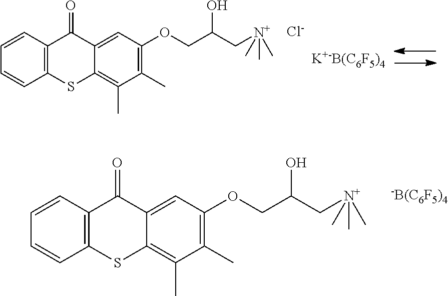

E optionally being combined with a photosensitizer based on 9,10-dibutoxyanthracene and phenanthrenequinone or camphorquinone,
a dispersant Dispersbykl 640®,
and a filler e.g. quartz (granulometry 1.5 μm, marketed by the company SCHOTT under reference G018-163 UF1.5 treated with 2% of glycidyltrimethoxysilane).

PCT application WO-A-2006/073021 discloses a cationically polymerizable/cross-linkable composition comprising a monomer UVR6105, a photoinitiator [Cyracure® UVI6992 or an iodonium hexafluorophosphate (CGI552)] with a content of 4.8 or 2 wt. % relative to the monomer and a photosensitizer containing a dialkoxyanthracene. In this composition, the photoinitiator is not an iodonium borate. This PCT application WO-A-2006/073021 is therefore outside of the scope of the invention, which relates more particularly to polymerizable/cross-linkable compositions containing initiator systems based on iodonium borates, such as [B(C₆F₅)₄]⁻, [CH(CH₃)₂—C₆H₄)—I—C₆H₄—CH₃]⁺.

Now, it is found that although the photoinitiators of the onium borate type have particularly good performance, they have the slight drawback that they have a characteristic odour, which we could well do without in certain applications, for example food-grade varnishes. This odour is connected in particular with the decomposition of the photoinitiator during photopolymerization.

The economic aspect is another element to be taken into account industrially, for these polymerizable/cross-linkable compositions based on iodonium borates. Knowing that the iodonium borates have a certain impact in this respect, it would be useful to be able to reduce the concentration of these photoinitiators based on iodonium borates in processes using the aforesaid polymerizable/cross-linkable compositions. As a corollary, this would also attenuate the odour of these polymerized/cross-linked compositions.

In these circumstances, one of the essential objectives of the present invention is to provide a novel method for preparing a hard film or coating, from polymerizable/cross-linkable compositions whose initiator systems are based on iodonium borates and whose concentration of cationic initiator system is reduced, without loss of effectiveness, while being easy to handle and of low toxicity, and accordingly make it possible to obtain films, coatings (varnishes, inks, non-stick coatings e.g. for paper or polymer film) and/or composites having some or all of the following properties:

[symbol] the coatings adhere well to their substrates,

[symbol] the varnishes are perfectly printable

[symbol] they do not yellow over time and/or after curing.

One of the objectives to be achieved for the present invention is to provide a novel method for preparing a hard film or coating, from cationically polymerizable/cross-linkable compositions and, under photoactivation and/or thermal activation and/or electron beam activation, whose initiator systems are based on iodonium borates and whose odour (in particular after polymerization/cross-linking) is acceptable, while offering good performance with respect to the greatest number of cationically polymerizable and/or cross-linkable monomers, oligomers and/or organofunctional polymers; the monomers, oligomers and/or polymers being in particular (1) of organic nature, preferably solely hydrocarbon, or (2) of polyorganosiloxane nature, optionally mixed (3) with other monomers, oligomers and/or polymers containing acrylic groups.

Another objective of the invention is to provide a novel method for preparing a hard film or coating, from compositions of this type having reactivities and rates of polymerization/cross-linking that are as high as possible, in particular so as to be able to increase the coating speeds, for example when coatings (varnishes) are involved.

Another objective of the invention is to provide a novel method for preparing a hard film or coating, from compositions of this type that can be used equally as a thin film, with thickness for example ranging from 0.1 to 1 μm, and as a thicker layer, with thickness for example ranging from a value greater than one micrometre to several centimetres.

Another objective of the invention is to provide a novel method for preparing a hard film or coating, from compositions of this type for the preparation of composites.

These various objectives are achieved by the invention, which relates firstly, in its first object, to a novel method for preparing a hard film or coating, from a cationically polymerizable and/or cross-linkable composition, characterized in that it essentially comprises the stages consisting of:
a. mixing:
   at least one cross-linkable and/or polymerizable monomer, oligomer and/or silicone polymer A bearing organofunctional groups each comprising at least one reactive function selected from the group comprising the following functions: epoxy, alkenylether, oxetane, dioxolane, carbonate, (meth)acrylate and all combinations thereof, the epoxy function being preferred;
   an effective quantity of at least one cationic photoinitiator B based on at least one onium salt of formula (I):

[(R¹)ₙ—I—(R²)ₘ]⁺ (I)
in which:
   the R¹ radicals, identical or different, represent a C₆-C₂₀ carbocyclic or heterocyclic aryl radical, and said heterocyclic radical can contain nitrogen and/or sulphur as heteroelements;
   the R² radicals, identical or different, correspond to the same definition as R¹ or represent a linear or branched C₁-C₃₀ alkyl radical, or a linear or branched C₁-C₃₀ alkenyl radical;
   said R¹ and R² radicals being optionally substituted with:
      a linear or branched C₁-C₃₀ alkyl group,
      an alkoxy group OR¹²,
      a ketone group —(C═O)—R¹²
      an ester or carboxyl group —(C═O)—O—R¹²,
      a mercapto group SR¹²,
      a mercapto group SOR¹²,
      R¹² being a radical selected from the group comprising a hydrogen atom, a linear or branched C₁-C₂₅ radical, a C₆-C₃₀ aryl radical, or an alkaryl radical whose alkyl part is linear or branched C₁-C₂₅ and the aryl part is C₆-C₃₀,
      a nitro group,
      a chlorine atom,
      a bromine atom,
      and/or a cyano group;
   n is an integer ranging from 1 to v+1, v being the valency of iodine;
   m is an integer ranging from 0 to v−1, with n+m=v+1;
and of at least one cationic entity of the onium borate type of formula (II):

[BXₐR³_{b}]⁻ (II)
in which:
   a and b are integers such that 0≦a≦4, 0≦b≦4, and a+b=4;
   the symbols X, identical or different, represent:
      a halogen atom selected from chlorine and/or fluorine with 0≦a≦3,
      an OH function with 0≦a≦2;
   and the R³ radicals, identical or different, represent:
      a phenyl radical substituted with at least one electron-accepting group such as —CF₃, —OCF₃, —NO₂, —CN, —SO₂R³⁰, —O(C═O)—R³⁰, —O—CₙF₂ₙ₊₁, —CₙF₂ₙ₊₁, R³⁰ being CₙF₂ₙ₊₁ with n=1 to 20, or substituted with at least 2 halogen atoms, in particular fluorine atoms,
      an aryl radical containing at least two aromatic rings such as biphenyl, naphthyl, optionally substituted with at least one halogen atom, in particular a fluorine atom or an electron-accepting group such as —CF₃, —OCF₃, —NO₂, —CN, —SO₂R¹⁴, —O(C═O)—R¹⁴, R¹⁴ being —O—CₙF₂ₙ₊₁, —CₙF₂ₙ₊₁, n being an integer between 1 and 20;
an effective quantity of at least one photosensitizer PSC selected from the diethers of formula (III):
   from the di-anthracene-ethers of formula (III.1):

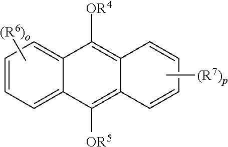

and/or from the di-naphthalene-ethers of formula (III.2):

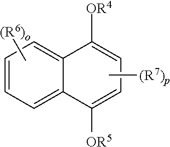

and/or from the di-benzene-ethers of formula (III.3):

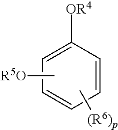

in which:
   the R⁴ and R⁵ groups, identical or different, represent a linear or branched C₁-C₃₀ alkyl radical, a linear or branched C₁-C₃₀ alkenyl radical, preferably an allyl, a C₆-C₂₀ aryl radical, preferably a benzyl,
      said R⁴ and R⁵ radicals being optionally substituted with an alkoxy group OR⁴⁵, R⁴⁵ being a radical selected from the group comprising a hydrogen atom, a linear or branched C₁-C₂₅ radical, a C₆-C₃₀ aryl radical, or an alkaryl radical whose alkyl part is linear or branched C₁-C₂₅ and the aryl part is C₆⁻C₃₀,
   and the R⁶ and R⁷ groups, identical or different, represent a radical that is unreactive on etherification, preferably a linear or branched C₁-C₃₀ alkyl radical, a linear or branched C₁-C₃₀ alkenyl radical, an alkoxy radical corresponding to the same definition as that given previously for OR⁴⁵, an amino radical, an alkylamino radical, an alkylsulphonyl radical, an alkoxycarbonyl radical or a halogen radical,
   o and p are integers such that 0≦o≦4, 0≦p≦4;
optionally an effective quantity of at least one photosensitizer PSD selected from the thioxanthones of formula (IV):

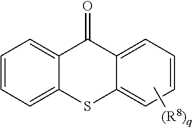

in which:
the R⁸ groups, identical or different, represent a linear or branched C₁-C₁₂ alkyl radical, a linear or branched C₆-C₁₂ cycloalkyl radical, preferably an allyl, a C₆-C₂₀ aryl radical, preferably a benzyl, an amino, hydroxy, —CN, —NO₂, -halogeno, —COOR⁹, —CHO, —O-phenyl, —SO₂-phenyl, —O-alkenyl or —SiR⁹ radical, with R⁹ corresponding to a C₁-C₁₂ lower alkyl;
optionally at least one dissolving agent E of the initiator B and/or of PSC and/or of

PSD;
optionally at least one organic solvent, preferably alcoholic;
b. applying the mixture obtained on a substrate; and
c. hardening the composition by cross-linking to a hard film or coating by the action of heat or radiation.

It is to the credit of the inventors that they selected this specific class of di-anthracene-ether and/or di-naphthalene-ether and/or di-benzene-ether photosensitizers PSC, in cationically polymerizable and/or cross-linkable compositions, to reduce the concentration of iodonium borate photoinitiators in said compositions, so that the odour associated with the latter before and/or polymerization/cross-linking is acceptable.

According to a very advantageous embodiment, the cross-linkable and/or polymerizable monomer, oligomer and/or polymer A is of organic nature and/or of polyorganosiloxane nature.

In a preferred embodiment, the monomer, oligomer and/or polymer A is liquid at room temperature or thermofusible at temperatures below 100° C., and, even more preferably, of organic nature and bearing organofunctional groups belonging to at least one of the following species:
α_{1.1} the cycloaliphatic epoxides, used alone or as a mixture thereof,
α_{1.2} the non-cycloaliphatic epoxides, used alone or as a mixture thereof,
α₂ the alkenyl-ethers, linear or cyclic, used alone or as a mixture thereof,
α₃ the polyols: used alone or as a mixture thereof.

In detail, this signifies that the monomer, oligomer and/or polymer A belong to at least one of the following organic species:
α_{1.1} cycloaliphatic epoxides, used alone or as a mixture thereof:
   the epoxides of the 3,4-epoxycyclohexylmethyl-3′,4′-epoxycyclohexane carboxylate type:

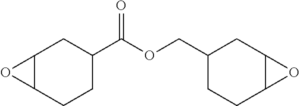

or Bis(3,4-epoxycyclohexypadipate, being particularly preferred;
α_{1.2} non-cycloaliphatic epoxides, used alone or as a mixture thereof:
   the epoxides such as those resulting from the condensation of Bisphenol A and of epichlorohydrin and of the type:
      di- and triglycidylethers of alkoxylated Bisphenol A of 1,6-hexanediol, of glycerol, of neopentylglycol and of propane trimethylol,
      or diglycidylethers of Bisphenol A,
   the epoxides of alpha-olefins, NOVOLAC epoxide, epoxidized soya oil and linseed oil, epoxidized polybutadiene, and more generally an epoxidized and monohydroxylated diene polymer, saturated or unsaturated, described in patent application WO-A-96/11215 obtained by epoxidation of a diene polymer of basic formula:

(HO)x-J-Lz-K—(OH)y

or (HO)x-J-K-L-(OH)y
in which:
   the symbols J and K represent sequences or blocks consisting of: homopolymers obtained by polymerization of a conjugated diene monomer having from 4 to 24 carbon atoms (for example: butadiene-1,3, isoprene or methyl-2 butadiene-1,3, phenyl-2 butadiene-1,3, pentadiene-1,3, dimethyl-3,4 hexadiene-1,3, diethyl-4,5 octadiene-1,3); copolymers obtained by copolymerization of at least two of the aforementioned conjugated dienes together; or copolymers obtained by copolymerization of at least one of the aforementioned conjugated dienes with at least one ethylenically unsaturated monomer selected from the aromatic vinyl monomers having from 8 to 20 carbon atoms (for example: styrene, ortho-, meta- or paramethylstyrene, vinyl mesitylene, vinyl naphthalene),
   the symbol L represents a polymer sequence or block obtained from the aforementioned aromatic vinyl monomers,
   x and y are numbers equal to zero or 1, x being equal to zero when y=1 and x being equal to 1 when y=0; and z is a number equal to zero or 1,
said basic diene polymer, on the one hand before epoxidation, which can be partially saturated by hydrogenation, and on the other hand after epoxidation, containing from 0.1 to 7 milliequivalents of epoxy function per gram of epoxidized and monohydroxylated diene polymer [as examples of epoxidized and monohydroxylated diene polymers the species obtained by epoxidation of the following basic diene polymers may be mentioned: Is-Bu-OH, Is-St/Bu-OH, Is-EtBu-OH or Is-St/EtBu-OH, where: the symbol Is is a polyisoprene block, the symbol Bu is a polybutadiene block, the symbol EtBu is a poly(ethylene-butylene) block (resulting from selective hydrogenation of a polybutadiene block), the symbol St is a polystyrene block (the whole St/Bu representing a block based on a random copolymer obtained by copolymerization of butadiene-1,3 and of styrene), and OH is a hydroxyl group (the whole -EtBu-OH signifying, for example, that the hydroxyl group donor is attached to the hydrogenated polybutadiene block)], being particularly preferred;
α₂ linear or cyclic alkenyl-ethers, used alone or as a mixture thereof:
   the vinyl-ethers, in particular the triethylene glycol divinyl ether, the cyclic vinyl ethers or the tetramers and/or dimers of acroleins, and the vinyl-ether with the following formula:

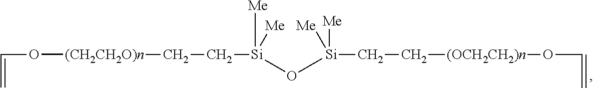

the propenyl-ethers,
and the butenyl-ethers, which are more especially preferred;
α₃ the polyols: used alone or as a mixture thereof, and preferably the compound with the following formula, 1 being greater than 1 and less than 100:

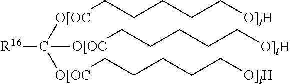

in which R is a linear or branched C₁-C₃₀ alkyl radical.

In another embodiment, the monomer, oligomer and/or polymer A is liquid at room temperature or thermofusible at temperatures below 100° C., and, even more preferably, of polyorganosiloxane nature, and constituted by units of formula (VI) and terminated by units of formula (VII) or cyclic constituted by units of formula (VI) represented below:

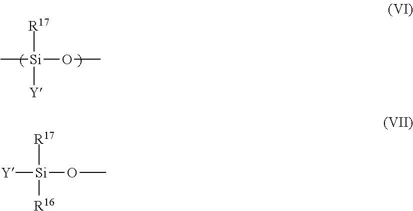

in which:
the symbol R¹⁶ is a linear or branched C₁-C₃₀ alkyl radical;
the symbols R¹⁷ are similar or different and represent:
   a linear or branched alkyl radical containing 1 to 8 carbon atoms, optionally substituted with at least one halogen, preferably fluorine, the alkyl radicals preferably being methyl, ethyl, propyl, octyl and 3,3,3-trifluoropropyl,
   a cycloalkyl radical containing between 5 and 8 cyclic carbon atoms, optionally substituted,
   an aryl radical containing between 6 and 12 carbon atoms which can be substituted, preferably phenyl or dichlorophenyl,
   a aralkyl part having an alkyl part containing between 5 and 14 carbon atoms and an aryl part containing between 6 and 12 carbon atoms, optionally substituted on the aryl part by halogens, alkyls and/or alkoxyls containing 1 to 3 carbon atoms;
the symbols Y′ are similar or different and represent:
   the R¹⁷ group,
   a hydrogen radical,
   and/or a cationically cross-linkable organofunctional group, preferably an epoxyfunctional and/or vinyloxyfunctional group, joined to the silicon of the polyorganosiloxane via a divalent radical containing from 2 to 20 carbon atoms and which can contain at least one heteroatom, preferably oxygen,
   and with at least one of the symbols Y′ representing a cationically cross-linkable functional organic group, for example oxirane, alkenylether, oxetane, dioxolane and/or carbonate.

According to an advantageous variant of the invention, at least one of the symbols R¹⁷ of the polyorganosiloxanes used within the scope of the invention as monomer(s), oligomer(s) or polymer(s) represents a phenyl, tolyl or dichlorophenyl radical.

According to another advantageous variant of the invention, the polyorganosiloxanes used have from 1 to 10 organofunctional groups per mole. For an epoxyfunctional group this corresponds to epoxide levels ranging from 20 to 2000 molar meq./100 g of polyorganosiloxane.

The linear polyorganosiloxanes can be oils with dynamic viscosity at 25° C. of the order of 10 to 10,000 mPa·s at 25° C., generally of the order of 50 to 5,000 mPa·s at 25° C. and, even more preferably, 100 to 600 mPa·s at 25° C., or gums having a molecular weight of the order of 1,000,000 g.mol⁻¹.

In the case of cyclic polyorganosiloxanes, these are constituted by units (VII) which can be for example of the dialkylsiloxy or alkarylsiloxy type. These cyclic polyorganosiloxanes have a viscosity of the order of 1 to 5,000 mPa·s at 25° C.

As examples of divalent radicals joining an organofunctional group of the epoxy type, those included in the following formulae may be mentioned:

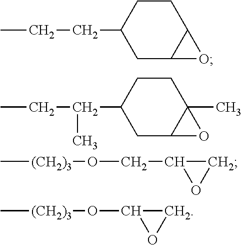

In the case of organofunctional groups of the alkenylether type, those contained in the following formulae may be mentioned:

—(CH₂)₃—O—CH═CH₂;

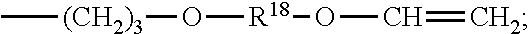

—(CH₂)₃—O—CH═CH—R¹⁹

in which:
R¹⁸ represents:
   a linear or branched C₁-C₁₂ alkylene radical, optionally substituted,
   or a C₅-C₁₂ arylene radical, preferably phenylene, optionally substituted, preferably with one to three C₁-C₆ alkyl groups;
   R¹⁹ represents a linear or branched C₁-C₆ alkyl radical.

According to a useful arrangement of the method of the invention, the polymerizable and/or cross-linkable composition is based on monomer(s) and/or oligomer(s) and/or polymer(s) A, of polyorganosiloxane nature and of organic nature, in particular hydrocarbon.

According to another useful arrangement of the method of the invention, the polymerizable and/or cross-linkable composition is based on monomer(s) and/or oligomer(s) and/or polymer(s) A, of polyorganosiloxane nature and/or of organic nature, in particular hydrocarbon, and further comprises monomers, oligomers and/or polymers with organofunctional groups of acrylate species; and in particular epoxidized acrylates, acrylo-glycero-polyester, multifunctional acrylates, acrylo-urethanes, acrylo-polyethers, acrylo-polyesters, unsaturated, acrylo-acrylic polyesters.

These acrylic species, optionally mixed, which can be used with monomer(s) and/or oligomer(s) and/or polymer(s) of polyorganosiloxane nature and/or of organic nature, are preferably selected from the following species: trimethylolpropane triacrylate, tripropylene glycol diacrylate, glycidylpropyl triacrylate, pentaerythritol triacrylate, trimethylolpropane ethoxylatetriacrylate, Bisphenol-A ethoxylate diacrylate, tripropylene glycol diacrylate, triethylene glycol diacrylate, tetraethylene glycol diacrylate, polyether acrylates, polyester acrylates (for example the product Ebecryl® 810 from the company UCB-Radcure), and epoxy acrylates (for example the product Ebecryl® 600 from the company UCB-Radcure).

It is recalled that, in the present specification, the expression “acrylic” covers the compounds comprising the function of the CH₂═CH—COO— type or of the CH₂═C(CH₃)—COO type.

The monomer, oligomer and/or polymer A is for example selected from the group comprising:

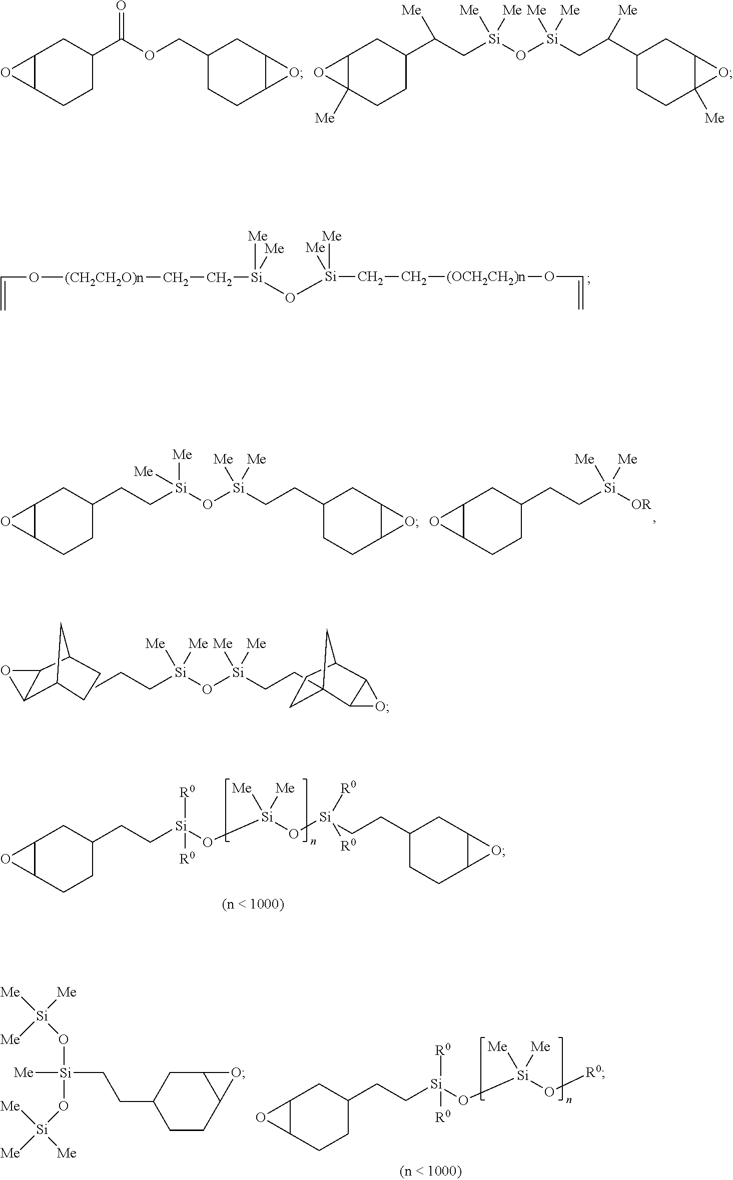

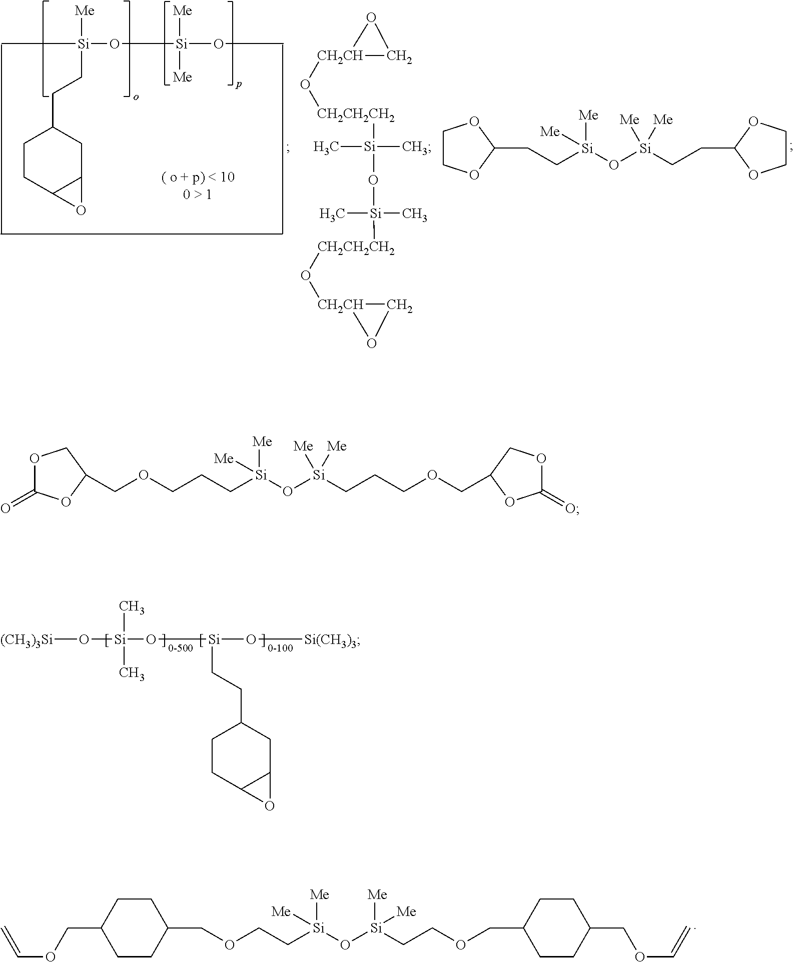

According to a variant, the monomer, oligomer and/or polymer A bears at least one functional group selected for example from the group comprising:

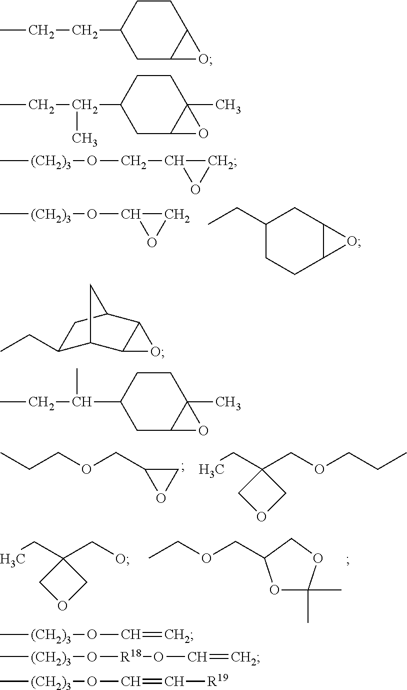

in which:
R¹⁸ represents:
   a linear or branched C₁-C₁₂ alkylene radical, optionally substituted,
   or a C₅-C₁₂ arylene radical, preferably phenylene, optionally substituted, preferably with one to three C₁-C₆ alkyl groups;
R¹⁹ represents a linear or branched C₁-C₆ alkyl radical.

Advantageously, photoinitiator B is selected from the group comprising the iodonium borates:
whose anionic entity is selected from the group comprising [B(C₆F₅)₄]⁻, [B(C₆H₃(CF₃)₂)₄]⁻, [B(C₆H₄OCF₃)₄]⁻, [B(C₆H₄CF₃)₄]⁻, [(C₆F₅)₂BF₂]⁻, [C₆F₅BF₃]⁻, [B(C₆H₃F₂)₄]⁻, and mixtures thereof;
   preferably from the subgroup comprising B(C₆F₅)₄⁻, [B(C₆H₃(CF₃)₂)₄]⁻, [B(C₆H₄OCF₃)₄]⁻ and mixtures thereof;
and whose cationic entity of the iodonium borate is selected from the group comprising:
   [(C₆H₅)₂I]⁺,
   [C₈H₁₇—O—C₆H₄—I—C₆H₅]⁺,
   [C₁₂H₂₅—C₆H₄—I—C₆H₅]⁺,
   [(C₈H₁₇O—C₆H₄)₂I]⁺,
   [(C₈H₁₇)—O—C₆H₄—I—C₆H₅)]⁺,
   [(C₁₂H₂₅—C₆H₄)₂I]⁺,
   [(CH(CH₃))₂—C₆H₄)—I—C₆H₄—CH₃]⁺,
   [C₆H₅—O—C₆H₄—I—C₆H₅]⁺,
   [C₆H₅—(C═O)—C₆H₄—I—C₆H₅]⁺,
   [C₆H₅—O—C₆H₄—I—C₆H₄—O—C₆H₅]⁺,
   [C₆H₅—(C═O)—C₆H₄—I—C₆H₄—(C═O)—C₆H₅]⁺,
   [C₆H₅—I—C₆H₄—O—CH₂—O—C(OH)—C₁₂H₂₅]⁺,
   and mixtures thereof.

By effective catalytic quantity of initiator is meant, according to the invention, the quantity that is sufficient to initiate polymerization and/or cross-linking. This quantity is generally between 0.01 and 20 parts by weight, most often between 0.05 and 8 parts by weight for polymerizing and/or cross-linking 100 parts by weight of component A (matrix).

The iodonium borates B to which the present invention relates can be prepared by an exchange reaction between a salt of the cationic entity (halide such as for example chloride, iodide) with an alkali metal salt of the anionic entity (sodium, lithium, potassium).

The operating conditions (respective amounts of reagents, choice of solvents, duration, temperature, stirring) are within the scope of a person skilled in the art; they should allow the required onium borate to be recovered in solid form by filtration of the precipitate formed or in the form of oil by extraction using a suitable solvent. The procedures for synthesis of the iodides of the aforementioned cationic entities are known per se. In this connection, reference may in particular be made to patent EP-0 562 897. The procedures for synthesis of the alkali metal salts of the borate anionic entity are also known per se; in particular for example in patent EP-0 562 897.

The photosensitizer PSC can be selected:
from the di-anthracene-ethers of formula (III.1), and even more preferably from those of the following formulae:

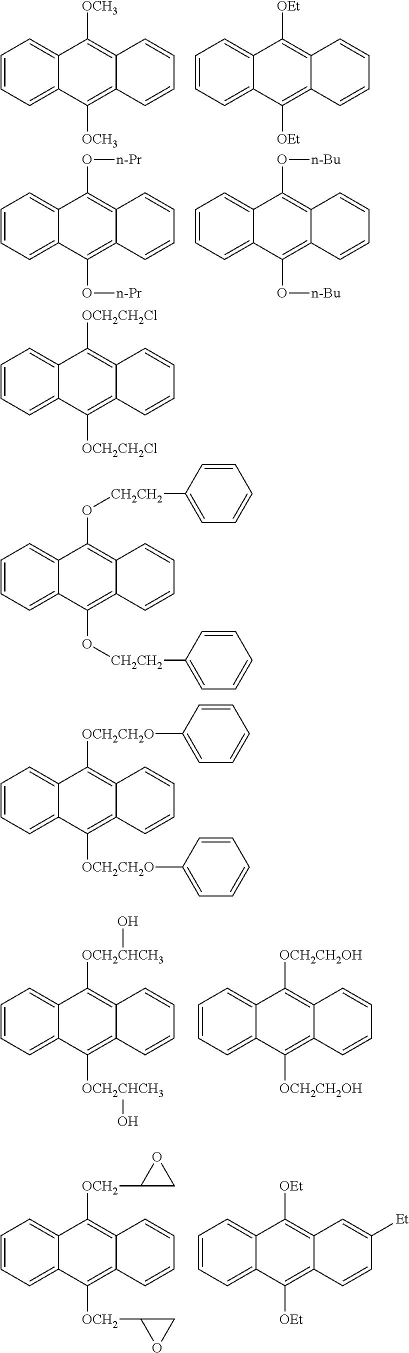

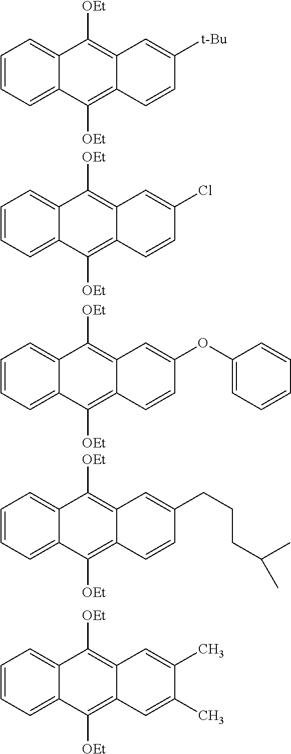

and/or from the di-naphthalene-ethers of formula (III.2), and even more preferably from those of the following formulae:

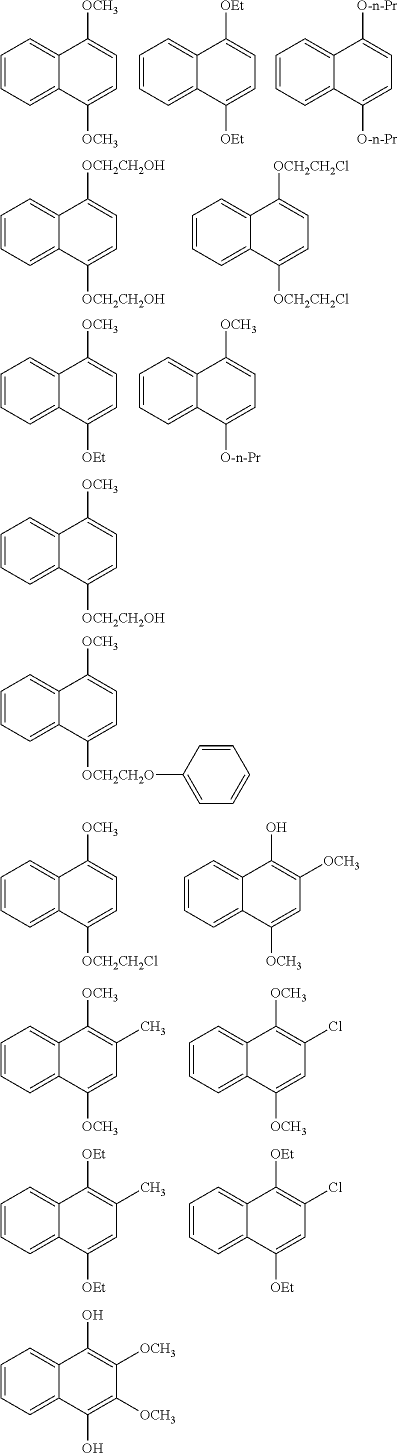

and/or from the di-benzene-ethers of formula (III.3), and even more preferably that of the following formula:

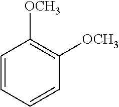

These di-anthracene-ethers, naphthalenes or benzenes PSC of formula (III.1) (III.2) (III.3) are in particular described in WO-A-2006/073021.

By effective catalytic quantity of photoinitiator C is meant, according to the invention, the quantity that is sufficient to make up for the decrease in the quantity of B, i.e. polymerization and/or cross-linking takes place under conditions of time and quality equivalent to those of a composition known from the prior art. Said quantity of PSC is generally between 0.01 and 5 parts by weight, most often between 0.01 and 0.5 parts by weight for polymerizing and/or cross-linking 100 parts by weight of component A (matrix), the quantity of B being reduced by about 5 to 40%, preferably 15 to 35%, and more preferably by about 25% relative to the quantity of it that is necessary in the absence of PSC, i.e. a quantity of B generally between 0.01 and 20 parts by weight, most often between 0.05 and 8 parts by weight.

Apart from the photosensitizers PSC and PSD, the composition can comprise at least one other aromatic hydrocarbon photosensitizer PSD′ with one or more aromatic rings, substituted or unsubstituted, having a residual absorption of light between 200 and 500 nm. This photosensitizer PSD′ can be of very varied nature. It can in particular correspond to one of the formulae (IV) to (XI) and (XIII) to (XXII) described on pages 8 to 15 of WO-A-00/19966 or alternatively to at least one of the benzophenones described on page 4 line 33 to page 7 line 12, and page 8 line 9 to line 13 of WO-A-99/05181.

As examples of optional agent E for the dissolution of initiator B and/or of PSC and/or of PSD, those selected from the group comprising: the oxetanes, the vinyl ethers and mixtures thereof may be mentioned.

As examples of optional organic, preferably alcoholic solvent F, those selected from the group comprising: isopropyl alcohol, 4-hydroxy-4-methyl-2-pentanone-diacetone, butyl lactate and mixtures thereof may be mentioned.

The concentrations of PSC and of B take into account the significant advantages of the invention in terms of attenuation of odour of the iodonium borate photoinitiator after photodecomposition and in terms of reduction of the concentration of iodonium borate photoinitiator. Thus, in wt. %:
A≧50
B≦5
0.01≦C≦5,
   preferably 0.01≦C≦0.5,
   and more preferably 0.01≦C≦0.1
0≦D≦50
0≦E≦50
0≦F≦50.

Preferably, the concentrations are as follows, in wt. %:
A≧50
B≦5
0.01≦C<0.1
0≦D≦50
0≦E≦50
0≦F≦50.

In the case when A is of organic nature, the concentrations can advantageously be as follows, in wt. %:
A≧70
B≦4
0.01≦C≦5
   preferably 0.01≦C≦0.5,
   and more preferably 0.01≦C≦0.1
0≦D≦2
0≦E≦20
0≦F≦10.

Preferably, in the case when A is of organic nature, the concentrations are as follows, in wt. %:
A≧70
B≦4
0.01≦C<0.1
0≦D≦2
0≦E≦20
0≦F≦10.

In the case when A is of polyorganosiloxane nature, the concentrations can advantageously be as follows, in wt. %:
A≧80
B≦1
0.01≦C≦0.5
   preferably 0.01≦C≦0.2,
   and more preferably 0.01≦C≦0.1
0≦D≦1
0≦E≦10
0≦F≦10.

Preferably, in the case when A is of polyorganosiloxane nature, the concentrations are as follows, in wt. %:
A≧80
B≦1
0.01≦C<0.1
0≦D≦1
0≦E≦10
0≦F≦10.

The compositions according to the invention optionally comprise a polymerization and/or cross-linking accelerator, and optionally also one or more additives selected from those generally known in the applications for which these compositions are intended.

When the polymerizable and/or cross-linkable composition is based on at least one of the organic species α_{1.1} to α₃, optionally mixed with monomers, oligomers and/or polymers of acrylic nature, the additives can in particular be compounds optionally in the form of polymers, with mobile hydrogens such as alcohols, glycols and polyols, useful for improving the flexibility of the hardened material after polymerization and/or cross-linking; for example the polycaprolactone-polyols, in particular the polymer obtained starting from 2-ethyl-2-(hydroxymethyl)-1,3-propane-diol and 2-oxepanone such as the product TON POLYOL®-301 marketed by the Company UNION CARBIDE, or the other commercial polymers TONE POLYOL® 201 and TONE POLYOL® 12703 from the company UNION CARBIDE may be mentioned. Moreover, in this case, as additives, the long-chain alkyl diacids, the fatty esters of unsaturated acids, whether or not epoxidized may be mentioned, for example epoxidized soya oil or epoxidized linseed oil, epoxidized 2-ethylhexylester, 2-ethylhexyl epoxy stearate, octyl epoxystearate, epoxidized acrylic esters, epoxidized soya oil acrylates, epoxidized linseed oil acrylates, diglycidic ether of glycolpolypropylene, long-chain aliphatic epoxides, etc.

These supplementary additives can also be, regardless of the nature of the polymerizable matrix, for example: mineral fillers such as in particular ground synthetic (polymer) or natural fibres, calcium carbonate, talc, clay, titanium dioxide, precipitated silica or fumed silica; soluble dyes; oxidation and corrosion inhibitors; organosilicon or non-organosilicon adherence modulators; fungicides, bactericides, anti-microbial agents; and/or any other material that does not interfere with the catalytic activity of the initiator and does not absorb in the wavelength range selected for photoactivation.

According to another of its aspects, the present invention relates to a hard film or coating obtained by the method defined above.

Advantageously, said coating is a varnish, an adhesive coating, a non-stick coating and/or an ink.

According to yet another of its aspects, the present invention relates to a composite material that can be obtained from a hard film or coating obtained by the method described above.

According to yet another of its aspects, the present invention also covers an object of which at least one surface is coated with the film or coating obtained by the method described above, by a composite material defined previously.

The invention also relates to the use of an effective quantity of at least one photosensitizer PSC selected from the diethers of formula (III) as defined above in a cationically polymerizable and/or cross-linkable composition, with thermal activation and/or actinic activation by radiation and/or by electron beam activation (preferably actinic) comprising at least one monomer, oligomer and/or polymer A as defined above, at least one photoinitiator B as defined above, optionally an effective quantity of at least one photosensitizer PSD as defined above or selected from the thioxanthone salts substituted with at least one group G comprising an ammonium function and having the formula (V):

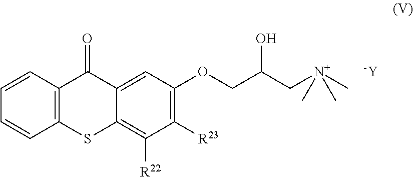

in which:
R²² R²³ are identical or different and represent a hydrogen or a C₁-C₁₀ alkyl radical, optionally substituted, preferably R²²═R²³=methyl;
(Y⁻) is an anionic entity selected from the group comprising: BF4⁻, PF₆⁻, SbF₆⁻; the anion (II) of formula [BXₐR³_{b}]⁻ defined below, RfSO₃⁻; (RfSO₂)₃C⁻ or (RfSO₂)₂N⁻, where Rf is a linear or branched alkyl radical, substituted with at least one halogen atom, preferably a fluorine atom, and even more preferably (Y⁻) is selected from the borates of the following formulae: [B(C₆F₅)₄]⁻ and [B(C₆H₃(CF₃)₂)₄]⁻;
optionally at least one dissolving agent E of initiator B and/or of PSC and/or of PSD as defined above and optionally at least one organic solvent F as defined above;
to reduce the quantity of photoinitiator B in said composition.

This decrease in the quantity of photoinitiator B, by using the photosensitizer PSC defined above, makes it possible to combat the unpleasant odour of said composition before and/or after polymerization/cross-linking.

The following examples are given by way of illustration. In particular they will make it easier to understand the invention and will highlight all of its advantages and will illustrate some of its various applications.

### EXAMPLES

The hard films and coatings in question are organic inks and varnishes.

A. The monomers used are cationically photopolymerizable monomers.

For these examples, the tests are conducted with 3,4-epoxycyclohexylmethyl-3,4-epoxycyclohexylcarboxylate [RN-CAS=2386-87-0]. More particularly, a commercial sample from Dow Chemical, UVR-6105, is used:

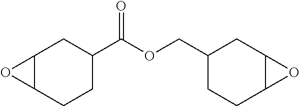

B. The photoinitiator used in these examples is tolylcumyliodonium borate [RN-CAS=178233-72-2] corresponding to the formula:

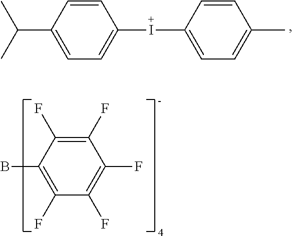

For these examples, it is designated B.

C. The photosensitizer PSC used in this study is 9,10-dibutoxyanthracene [RN-CAS=76275-14-4] of chemical formula:

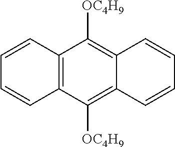

For these examples, it is designated PSC or DBA.

### EXPERIMENTAL SECTION

### Formulations:

The reference formulation corresponds to a mixture containing:
1 part of CPTX
2 parts of B
8 parts of TMPO
39 parts of A=UVR 6105

CPTX is a photosensitizer PSD in the thioxanthone family: 1-chloro-4-propoxythioxanthone [RN-CAS=142770-42-1] which is particularly effective with B. The chemical formula of CPTX is as follows:

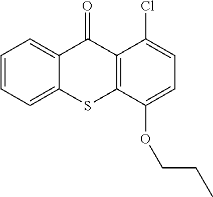

TMPO is a dissolving agent E constituted by an oxetane used for facilitating the dissolution of PI and the photosensitizers in monomer A=UVR 6105 and which also makes it possible to increase the reactivity. The formula of TMPO is as follows:

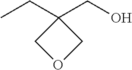

The following examples concern, on the one hand, the proportion of B, and on the other hand the effect of the addition of PSC=DBA. Formulations containing 2, 1.75 and 1.5 parts of B are prepared and tested. In order to study the effect of adding DBA, formulations were prepared by adding from 100 to 1000 ppm of DBA to the aforesaid formulations.

### Dissolution

Dissolution is carried out by first introducing TMPO, CPTX, PI and DBA, and then UVR6105. The mixture is placed on the rollers for about an hour. The formulation is then ready for testing.

### Coating

Coating is carried out on aluminium plates. The coating operation is performed manually using a Meyer bar 0. The thickness of the layers obtained is a few microns.

### Cross-Linking

The plates coated in this way are cross-linked in the IST UV bench. The cross-linking conditions are given below:

1 Hg lamp—100 W/cm,

Speed 100 m/min or 50 m/min,

1 single pass.

### Tests

On leaving the UV bench, cross-linking is verified on the basis of being touch-dry.

24 hours after leaving the UV bench, the various coatings are tested for resistance to MEK (methyl ethyl ketone, CAS No.: 78-93-3).

The test for resistance to MEK consists of soaking a piece of cotton wool with methyl ethyl ketone, then going back and forth on the coated part until there is partial destruction of the film. The number of movements back and forth before destruction corresponds to the resistance to MEK. A control coating is produced and tested on each plate. In our test this control coating is based on the reference formulation described below. Resistance to MEK is not an absolute value but always a comparison against this control.

### Reference

The reference formulation is coated in parallel with each formulation tested given below for evaluating the variations.

| | Reference Formulation |
|---|---|
| PSD: CPTX (parts) | 1 |
| B (parts) | 2 |
| E: TMPO (parts) | 8 |
| A: UVR6105 (parts) | 39 |
| PSC: DBA | 0 |
| (parts/ppm/wt. %) | |

### Formulations I and II:

The following two formulations were tested to demonstrate the effect of decreasing the proportion of B:

| Formulations | I | II |
|---|---|---|
| PSD: CPTX (parts) | 1 | 1 |
| B (parts) | 1.75 | 1.50 |
| E: TMPO (parts) | 8 | 8 |
| A: UVR6105 (parts) | 39 | 39 |
| PSC: DBA | 0 | 0 |
| (parts/ppm/wt. %) | | |

| For- | | | | | | | |
|---|---|---|---|---|---|---|---|
| mu- | | | | | | | |
| lations | B | PSC:DBA | Speed | | Power | | |
| No. | (parts) | (ppm) | m/min | Lamps | W/cm | Dry | MEK |
| Refer- | 2 | 0 | 100 | 1 | 100 | yes | 80 |
| ence | | | | | | | |
| Refer- | 2 | 0 | 50 | 1 | 100 | yes | 100 |
| ence | | | | | | | |
| I | 1.75 | 0 | 100 | 1 | 100 | yes | 80 |
| I | 1.75 | 0 | 50 | 1 | 100 | yes | 100 |
| II | 1.50 | 0 | 100 | 1 | 100 | yes | 70 |
| II | 1.50 | 0 | 50 | 1 | 100 | yes | 80 |

A drop in resistance to MEK is observed when the proportion of B present in the formulation is reduced by 25% (Formulation II).

### Examples 1, 2 and 3

The effect of adding DBA is investigated by preparing the formulations of Examples 1, 2 and 3.

| | Example 1 | Example 2 | Example 3 |
|---|---|---|---|
| PSD: CPTX (parts) | 1 | 1 | 1 |
| B (parts) | 2 | 2 | 2 |
| E: TMPO (parts) | 8 | 8 | 8 |
| A: UVR6105 (parts) | 38.99 | 38.98 | 38.95 |
| PSC: DBA (parts) | 0.01 | 0.02 | 0.05 |
| PSC: DBA (ppm) | 200 | 400 | 1000 |
| PSC: DBA (wt. %) | 0.02 | 0.04 | 0.10 |

| For- | | | | | | | |
|---|---|---|---|---|---|---|---|
| mu- | | | | | | | |
| lations | B | PSC:DBA | Speed | | Power | | |
| No. | (parts) | (ppm) | m/min | Lamps | W/cm | Dry | MEK |
| Refer- | 2 | 0 | 100 | 1 | 100 | yes | 80 |
| ence | | | | | | | |
| 1 | 2 | 200 | 100 | 1 | 100 | yes | 90 |
| 2 | 2 | 400 | 100 | 1 | 100 | yes | 80 |
| 3 | 2 | 1000 | 100 | 1 | 100 | yes | 80 |

Adding a very small quantity of PSC:DBA (200 ppm, i.e. 0.02 wt. %) increases the resistance to MEK. For additions of 400 and 1000 ppm of PSC:DBA (respectively 0.04 and 0.10 wt. %), no effect on resistance to MEK is observed.

### Examples 4, 5 and 6

This last series of examples investigates the effect of adding DBA on formulations whose proportion of B has been reduced.

| | Example 4 | Example 5 | Example 6 |
|---|---|---|---|
| PSD: CPTX (parts) | 1 | 1 | 1 |
| B (parts) | 1.75 | 1.5 | 1.75 |
| E: TMPO (parts) | 8 | 8 | 8 |
| A: UVR6105 (parts) | 38.99 | 38.99 | 38.995 |
| PSC: DBA (parts) | 0.01 | 0.01 | 0.005 |
| PSC: DBA (ppm) | 200 | 200 | 100 |
| PSC: DBA (wt. %) | 0.0201 | 0.0202 | 0.0101 |

| For- | | | | | | | |
|---|---|---|---|---|---|---|---|
| mu- | | | | | | | |
| lations | B | PSC:DBA | Speed | | Power | | |
| No. | (parts) | (ppm) | m/min | Lamps | W/cm | Dry | MEK |
| Refer- | 2 | 0 | 100 | 1 | 100 | yes | 80 |
| ence | | | | | | | |
| Refer- | 2 | 0 | 50 | 1 | 100 | yes | 100 |
| ence | | | | | | | |
| 4 | 1.75 | 200 | 100 | 1 | 100 | yes | 90 |
| 4 | 1.75 | 200 | 50 | 1 | 100 | yes | 100 |
| 5 | 1.50 | 200 | 100 | 1 | 100 | yes | 90 |
| 5 | 1.50 | 200 | 50 | 1 | 100 | yes | 100 |
| 6 | 1.75 | 100 | 100 | 1 | 100 | yes | 90 |
| 6 | 1.75 | 100 | 50 | 1 | 100 | yes | 100 |

Addition of PSC:DBA improves the properties of resistance to MEK whereas the proportion of photoinitiator is reduced. By adding 200 ppm of PSC:DBA (i.e. 0.02 wt. %), the proportion of B can be reduced by 25% while improving the resistance to MEK.

### Examples 7 to 12

A: Epoxy Silicone of the type

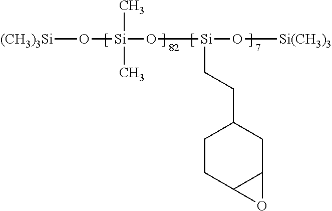

B: [B(C₆F₅)₄]⁻, [(CH(CH₃)₂—C₆H₄)—I—C₆H₄—CH₃]⁺
PSC:DBA
Solvent E: isopropyl alcohol, 4-hydroxy-4-methyl-2-pentanone, diacetone[CAS=123-42-2], butyl lactate [CAS=34451-19-9]

The reference formulations Ref1, Ref2 and Ref3 contain:

100 parts of Epoxy Silicone A as defined above.

0.5 part of B as defined above.

2 parts of E selected from the compounds defined above.

The following examples 7 to 12 concern the effect of the addition of PSC:DBA on the kinetics of cross-linking of Epoxy Silicone A.

The applications to which these examples relate are in particular non-stick coatings based on cross-linked silicone.

Dissolution is carried out by first introducing B and the solvent E, then the Epoxy Silicone A. The mixture is placed on the rollers for about an hour. The formulation is then ready for testing.

The PSC:DBA is preferably added before the Epoxy Silicone A.

The test corresponds to measurement of the gel time under UV.

| | Ref 1 | Ex 7 | Ex 8 | Ref 2 | Ex 9 | Ex 10 | Ref 3 | Ex 11 | Ex 12 |
|---|---|---|---|---|---|---|---|---|---|
| A:Epoxy Silicone | 100 | 100 | 100 | 100 | 100 | 100 | 100 | 100 | 100 |
| B | 0.5 | 0.5 | 0.5 | 0.5 | 0.5 | 0.5 | 0.5 | 0.5 | 0.5 |
| E:IPA | 2 | 2 | 2 | | | | | | |
| E:Butyl lactate | | | | 2 | 2 | 2 | | | |
| E:Diacetone | | | | | | | 2 | 2 | 2 |
| Alcohol | | | | | | | | | |
| PSC:DBA (ppm) | 0 | 250 | 1000 | 0 | 250 | 1000 | 0 | 250 | 1000 |
| PSC:DBA (wt. %) | 0 | 0.0250 | 0.1025 | 0 | 0.0250 | 0.1025 | 0 | 0.0250 | 0.1025 |
| Gel Time (min) | 1 | 0.4 | 1.3 | 0.4 | 0.1 | 0.3 | >2 | 0.1 | >2 |

Regardless of which solvent is used, for small amounts of B (0.5 part) the addition of 250 ppm of PSC:DBA (i.e. 0.025 wt. %) significantly accelerates the kinetics of cross-linking of the epoxy silicone A. This test also shows that the quantity of B can be reduced while keeping reactivities and rates of polymerization/cross-linking as high as the references, and even better in certain conditions of concentrations of PSC:DBA. It can be seen that compensation for the decrease in the quantity of photoinitiator B by PSC:DBA does not affect (and improves for certain cases) the essential characteristics of polymerization of the composition.

1. Method for preparing a hard film or coating, from a cationically polymerizable and/or cross-linkable composition, characterized in that it essentially comprises the stages consisting of
a. mixing:
at least one cross-linkable and/or polymerizable monomer, oligomer and/or silicone polymer A bearing organofunctional groups each comprising at least one reactive function selected from the group comprising the following functions: epoxy, alkenylether, oxetane, dioxolane, carbonate, (meth)acrylate and all combinations thereof, the epoxy function being preferred;
an effective quantity of at least one cationic photoinitiator B based on at least one onium salt of formula (I):
[(R)¹)ₙ—I—(R²)ₘ]⁺ (I)
in which:
the R¹ radicals, identical or different, represent a carbocyclic or heterocyclic C₆-C₂₀ aryl radical, and said heterocyclic radical can contain nitrogen and/or sulphur as heteroelements,
the R² radicals, identical or different, correspond to the same definition as R¹ or represent a linear or branched C₁-C₃₀ alkyl radical, or a linear or branched C₁-C₃₀ alkenyl radical,
said R¹ and R² radicals being optionally substituted with:
a linear or branched C₁-C₃₀ alkyl group,
an alkoxy group OR¹²,
a ketone group —(C═O)—R¹²
an ester or carboxyl group —(C═O)—O—R¹²,
a mercapto group SR¹²,
a mercapto group SOR¹²,
R¹² being a radical selected from the group comprising a hydrogen atom, a linear or branched C₁-C₂₅ radical, a C₆-C₃₀ aryl radical, or an alkaryl radical whose alkyl part is linear or branched C₁-C₂₅ and the aryl part is C₆-C₃₀,
a nitro group,
a chlorine atom,
a bromine atom,
and/or a cyano group,
n is an integer ranging from 1 to v+1, v being the valency of iodine,
m is an integer ranging from 0 to v−1, with n+m=v+1;
and at least one cationic entity of the onium borate type of formula (II):
[BXₐR³_{b}]⁻ (II
in which:
a and b are integers such that 0≦a≦4, 0≦b≦4, and a+b=4,
the symbols X, identical or different, represent:
a halogen atom selected from chlorine and/or fluorine with 0≦a≦3,
an OH function with 0≦a≦2,
and the R³ radicals, identical or different, represent:
a phenyl radical substituted with at least one electron-accepting group such as —CF₃, —OCF₃, —NO₂, —CN, —SO₂R³⁰, —O(C═O)—R³⁰, —O—CₙF₂ₙ₊₁, —CₙF₂ₙ₊₁, R³⁰ being CₙF₂ₙ₊₁ with n=1 to 20, or substituted with at least 2 halogen atoms, in particular fluorine atoms,
an aryl radical containing at least two aromatic rings such as biphenyl, naphthyl, optionally substituted with at least one halogen atom, in particular a fluorine atom or an electron-accepting group such as —CF₃, —OCF₃, —NO₂, —CN, —SO₂R¹⁴, —O(C═O)—R¹⁴, R¹⁴ being —O—CₙF₂ₙ₊₁, —CₙF₂ₙ₊₁, n being an integer between 1 and 20;
an effective quantity of at least one photosensitizer PSC selected from the diethers of formula (III):
from the di-anthracene-ethers of formula (III.1): 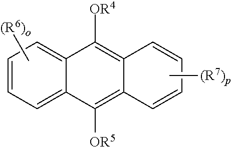
and/or from the di-naphthalene-ethers of formula (III.2): 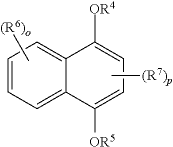
and/or from the di-benzene-ethers of formula (III.3): 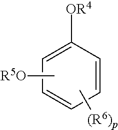
in which:
the R⁴ and R⁵ groups, identical or different, represent a linear or branched C₁-C₃₀ alkyl radical, a linear or branched C₁-C₃₀ alkenyl radical, preferably an allyl, a C₆-C₂₀ aryl radical, preferably a benzyl,
said R⁴ and R⁵ radicals being optionally substituted with an alkoxy group OR⁴⁵, R⁴⁵ being a radical selected from the group comprising a hydrogen atom, a linear or branched C₁-C₂₅ radical, a C₆-C₃₀ aryl radical, or an alkaryl radical whose alkyl part is linear or branched C₁-C₂₅ and the aryl part is C₆-C₃₀,
and the R⁶ and R⁷ groups, identical or different, represent a radical that is unreactive in etherification, preferably a linear or branched C₁-C₃₀ alkyl radical, a linear or branched C₁-C₃₀ alkenyl radical, an alkoxy radical corresponding to the same definition as that given previously for OR⁴⁵, an amino radical, an alkylamino radical, an alkylsulphonyl radical, an alkoxycarbonyl radical or a halogen radical,
o and p are integers such that 0≦o≦4, 0≦p≦4;
optionally an effective quantity of at least one photosensitizer PSD selected from the thioxanthones of formula (IV): 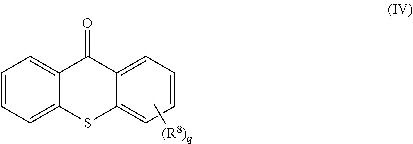
in which:
the R⁸ groups, identical or different, represent a linear or branched C₁-C₁₂ alkyl radical, a linear or branched C₆-C₁₂ cycloalkyl radical, preferably an allyl, a C₆-C₂₀ aryl radical, preferably a benzyl, an amino, hydroxy, —CN, —NO₂, -halogeno, —COOR⁹, —CHO, —O-phenyl, —SO₂-phenyl, —O-alkenyl or —SiR⁹ radical, with R⁹ corresponding to a C₁-C₁₂ lower alkyl;
optionally at least one dissolving agent E of initiator B and/or of PSC and/or of PSD;
optionally at least one organic solvent, preferably alcoholic;
b. applying the mixture obtained on a substrate; and
c. hardening the composition by cross-linking to a hard film or coating by the action of heat or radiation.

2. Method according to claim 1, characterized in that the cross-linkable and/or polymerizable monomer, oligomer and/or polymer A is of organic nature and/or of polyorganosiloxane nature.

3. Method according to claim 2, characterized in that the monomer, oligomer and/or polymer A is of organic nature and bears organofunctional groups belonging to at least one of the following species:
α_{1.1} the cycloaliphatic epoxides, used alone or as a mixture thereof,
α_{1.2} the non-cycloaliphatic epoxides, used alone or as a mixture thereof,
α₂ the linear or cyclic alkenyl-ethers, used alone or as a mixture thereof,
α₃ the polyols: used alone or as a mixture thereof.

4. Method according to claim 3, characterized in that the monomer, oligomer and/or polymer A of organic nature is selected from the group comprising:
the species α_{1.1} consisting of 3,4-epoxycyclohexylmethyl-3′,4′-epoxycyclohexane carboxylate and bis(3,4-epoxycyclohexyl)adipate;
the species α_{1.2} consisting of:
the epoxides such as those resulting from the condensation of bis-phenol A optionally alkoxylated and of epichlorohydrin and optionally of 1,6-hexanediol, of glycerol, of neopentylglycol or of propane trimethylol,
the NOVOLAC epoxides,
the epoxidized and monohydroxylated, saturated or unsaturated diene polymers;
the species α₂ consisting of the vinyl-ethers, propenyl-ethers and butenyl-ethers.

5. Method according to claim 2, characterized in that the monomer, oligomer and polymer with organofunctional groups is of polyorganosiloxane nature, and constituted by units of formula (VI) and terminated by units of formula (VII) or cyclic constituted by units of formula (VI) represented below: 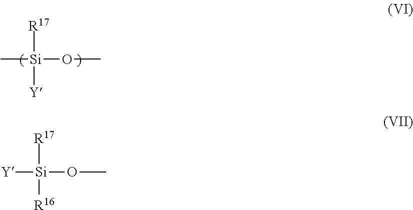
in which:
the symbol R¹⁶ is a linear or branched C₁-C₃₀ alkyl radical;
the symbols R¹⁷ are similar or different and represent:
a linear or branched alkyl radical containing 1 to 8 carbon atoms, optionally substituted with at least one halogen, preferably fluorine, the alkyl radicals preferably being methyl, ethyl, propyl, octyl and 3,3,3-trifluoropropyl,
a cycloalkyl radical containing between 5 and 8 cyclic carbon atoms, optionally substituted,
an aryl radical containing between 6 and 12 carbon atoms which can be substituted, preferably phenyl or dichlorophenyl,
an aralkyl part having an alkyl part containing between 5 and 14 carbon atoms and an aryl part containing between 6 and 12 carbon atoms, optionally substituted on the aryl part with halogens, alkyls and/or alkoxyls containing 1 to 3 carbon atoms;
the symbols Y′ are similar or different and represent:
the R¹⁷ group,
a hydrogen radical,
and/or a cationically cross-linkable organofunctional group, preferably an epoxyfunctional and/or vinyloxyfunctional group, joined to the silicon of the polyorganosiloxane via a divalent radical containing from 2 to 20 carbon atoms and which can contain at least one heteroatom, preferably oxygen,
and at least one of the symbols Y′ represents a cationically cross-linkable functional organic group.

6. Method according to claim 5, characterized in that at least one of the symbols R¹⁷ of the polyorganosiloxanes used represents a phenyl, tolyl or dichlorophenyl radical.

7. Method according to claim 5, characterized in that the polymerizable and/or cross-linkable composition further comprises monomers, oligomers and/or polymers with organofunctional groups defined in accordance with claim 3.

8. Method according to claim 1, characterized in that the polymerizable and/or cross-linkable composition additionally comprises monomers, oligomers and/or polymers with organofunctional groups of acrylate species; and in particular epoxidized acrylates, acrylo-glycero-polyesters, multifunctional acrylates, acrylo-urethanes, acrylo-polyethers, acrylo-polyesters, unsaturated acrylo-acrylic polyesters.

9. Method according to claim 1, characterized in that:
the monomer, oligomer and/or polymer A is selected from the group comprising: 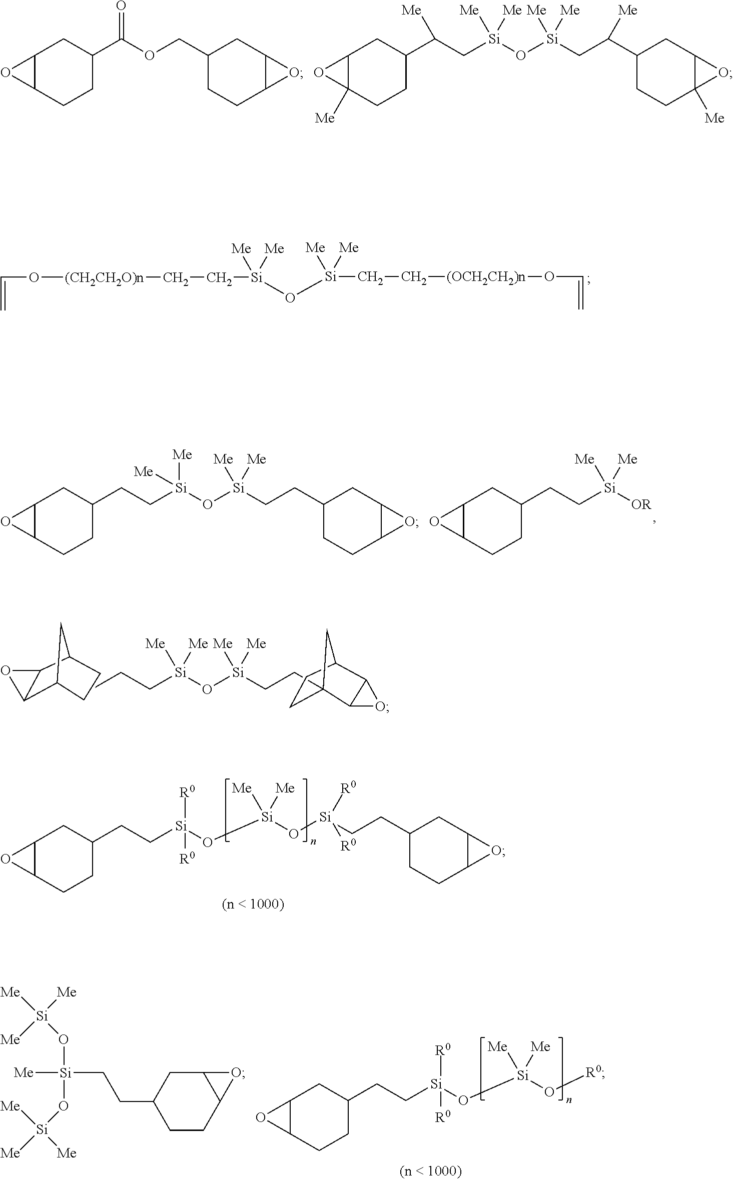 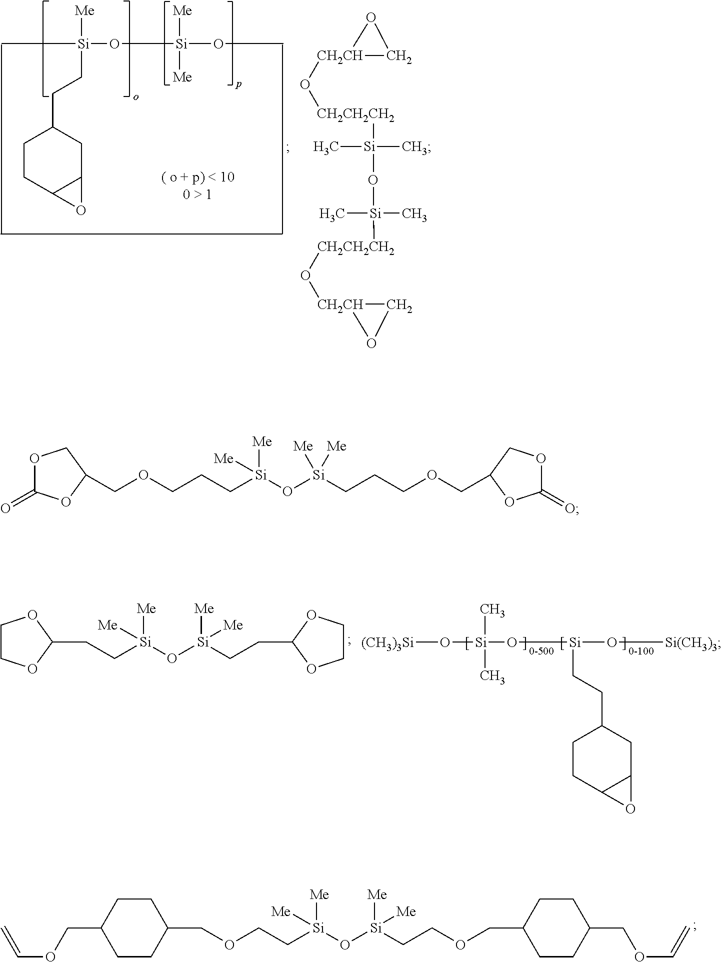
the monomer, oligomer and/or polymer A bears at least one functional group selected from the group comprising: 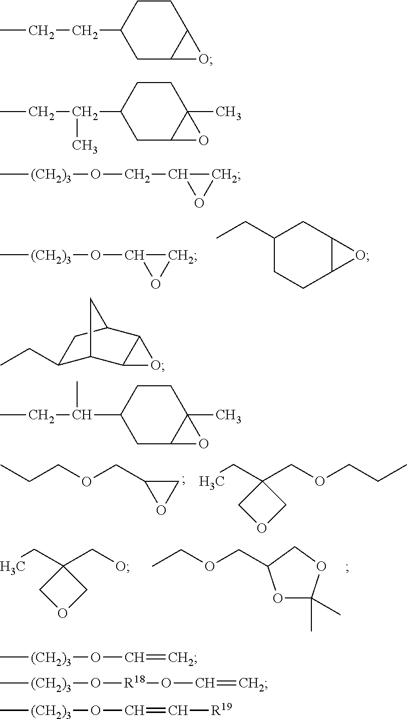
in which:
R¹⁸ represents:
a linear or branched C₁-C₁₂ alkylene radical, optionally substituted,
or a C₅-C₁₂ arylene radical, preferably phenylene, optionally substituted, preferably with one to three C₁-C₆ alkyl groups,
R¹⁹ represents a linear or branched C₁-C₆ alkyl radical.

10. Method according to claim 1, characterized in that photoinitiator B is selected from the group comprising the onium borates:
whose anionic entity is selected from the group comprising:
[B(C₆F₅)₄]⁻, [B(C₆H₃(CF₃)₂)₄]⁻, [B(C₆H₄OCF₃)₄]⁻, [B(C₆H₄CF₃)₄]⁻, [(C₆F₅)₂BF₂]⁻, [C₆F₅BF₃]⁻, [B(C₆H₃F₂)₄]⁻, and mixtures thereof;
preferably from the subgroup comprising B(C₆F₅)₄⁻, [B(C₆H₃(CF₃)₂)₄]⁻, [B(C₆H₄OCF₃)₄]⁻ and mixtures thereof;
and whose cationic entity of the iodonium borate is selected from the group comprising:
[(C₆H₅)₂I]⁺,
[C₈H₁₇—O—C₆H₄—I—C₆H₅]⁺,
[C₁₂H₂₅—C₆H₄—I—C₆H₅]⁺,
[(C₈H₁₇O—C₆H₄)₂I]⁺,
[(C₈H₁₇)—O—C₆H₄—I—C₆H₅)]⁺,
[(C₁₂H₂₅—C₆H₄)₂I]⁺,
[CH(CH₃)₂—C₆H₄)—I—C₆H₄—CH₃]⁺,
[C₆H₅—O—C₆H₄—i—C₆H₅]⁺,
[C₆H₅—(C═O)—C₆H₄—I—C₆H₅]⁺,
[C₆H₅—O—C₆H₄—I—C₆H₄—O—C₆H₅]⁺,
[C₆H₅—(C═O)—C₆H₄—I—C₆H₄—(C═O)—C₆H₅]⁺,
[C₆H₅—I—C₆H₄—O—CH₂—O—C(OH)—C₁₂H₂₅]⁺,
and mixtures thereof.

11. Method according to claim 1, characterized in that the photosensitizer PSC is selected from:
the di-anthracene-ethers of the following formulae: 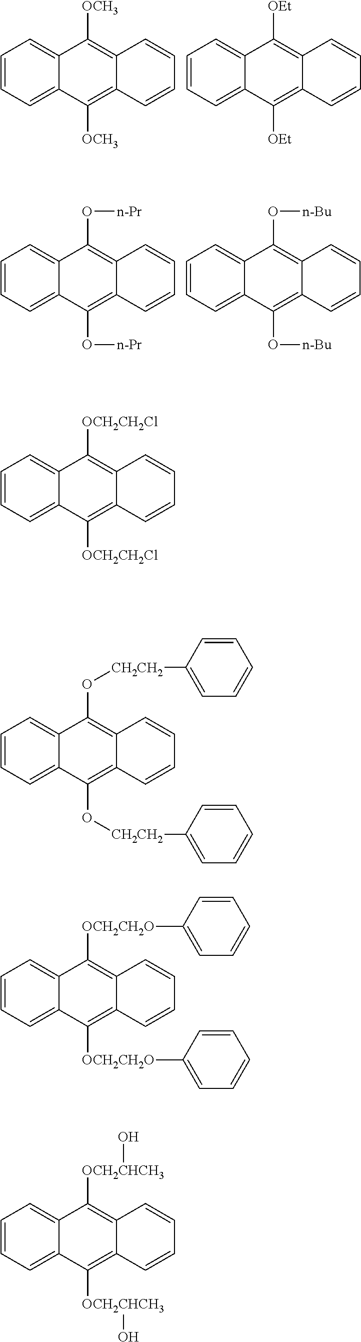 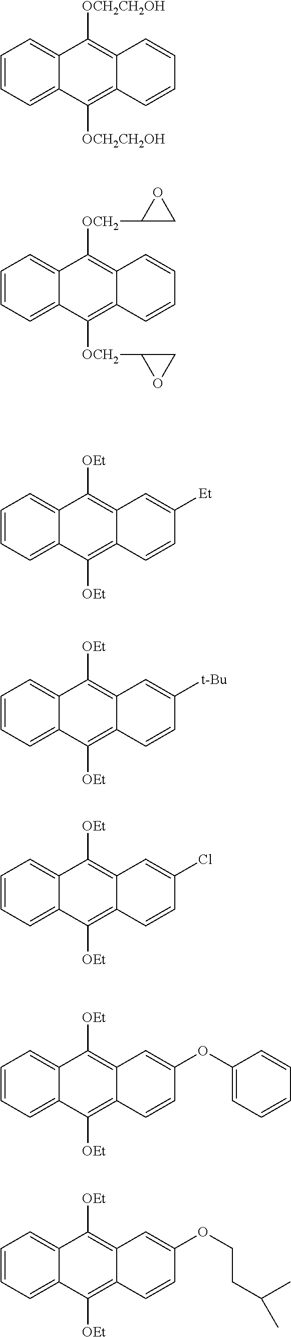 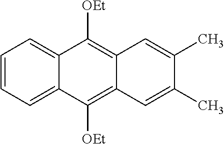
and/or the di-naphthalene-ethers of the following formulae: 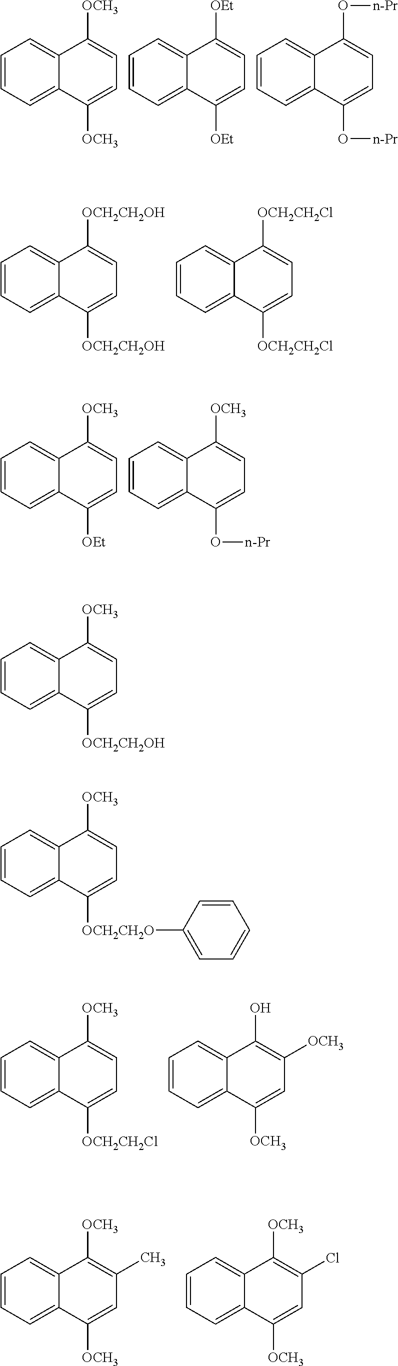 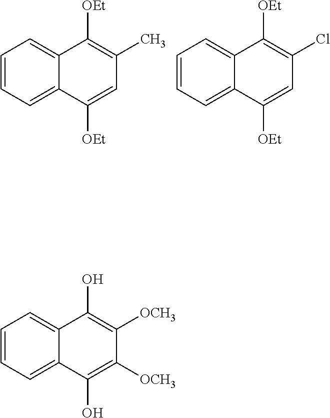
and/or the di-benzene-ether of the following formula:

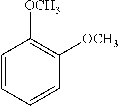

12. Method according to claim 1, characterized in that, in wt. %:
A≧50
B≦5
0.01≦C≦0.1
0≦D≦50
0≦E≦50
0≦F≦50

13. Hard film or coating obtained by the method according to claim 1.

14. Film or coating according to claim 13, characterized in that the coating is a varnish, an adhesive coating, a non-stick coating and/or an ink.

15. Composite material that can be obtained from a hard film or coating obtained by the method according to claim 1.

16. Object at least one surface of which is coated with film or coating according to claim 13, or with a composite material according to claim 15.

17. Use of an effective quantity of at least one photosensitizer PSC selected from the diethers of formula (III) as defined in claim 1 in a cationically polymerizable and/or cross-linkable composition, under thermal activation and/or actinic activation and/or by electron beam activation (preferably actinic) comprising at least one monomer, oligomer and/or polymer A as defined in claim 1, at least one photoinitiator B as defined in claim 1, optionally an effective quantity of at least one photosensitizer PSD as defined in claim 1 or selected from the thioxanthone salts substituted with at least one group G comprising an ammonium function and having the formula (V): 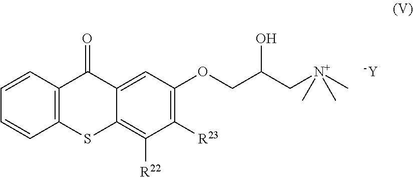
in which:
R²² and R²³ are identical or different and represent a hydrogen or a C₁-C₁₀ alkyl radical, optionally substituted, preferably R²²═R²³=methyl;
(Y⁻) being an anionic entity selected from the group comprising: BF₄⁻, PF₆⁻;SbF₆⁻; the anion (II) of formula [BXₐR³_{b}]⁻ defined in claim 1, RfSO₃⁻; (RfSO₂)₃C⁻ or (RfSO₂)₂N⁻, where Rf is a linear or branched alkyl radical, substituted with at least one halogen atom, preferably a fluorine atom, and even more preferably (Y⁻) is selected from the borates of the following formulae: [B(C₆F₅)₄]⁻ and [B(C₆H₃(CF₃)₂)₄]⁻;
optionally at least one dissolving agent E of the initiator B and/or of PSC and/or of PSD as defined in claim 1 and optionally at least one organic solvent F as defined in claim 1;
to reduce the quantity of photoinitiator B in said composition.
